(19) United States
(12) Patent Application Publication
(10) Pub. No.: US 2010/0060138 A1
(43) Pub. Date: Mar. 11, 2010

(54) LOW-PRESSURE DISCHARGE LAMP COMPRISING MOLECULAR RADIATOR AND ADDITIVE

(75) Inventors: Rainer Hilbig, Aachen (DE); Achim Gerhard Rolf Koerber, Kerkrade (NL); Stefan Schwan, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,274

(22) PCT Filed: Jun. 27, 2006
(86) PCT No.: PCT/IB06/52108

§ 371 Date: Dec. 20, 2007

(30) Foreign Application Priority Data
Jun. 29, 2005 (EP) 05105817.0

(51) Int. Cl. H01J 61/16; H01J 61/12; H01J 61/38

(52) U.S. Cl. 313/485; 313/637; 313/577; 313/643; 313/113

(57) ABSTRACT

In a low-pressure gas discharge lamp provided with a gas discharge vessel comprising a gas filling with a discharge-maintaining composition comprising a) a molecular radiator compound, b) hydrogen as an additive and c) a buffer gas, which low-pressure gas discharge lamp is further provided with means for generating and maintaining a low-pressure gas discharge, the addition of hydrogen comes up with the following advantages: an increase of plasma efficiency and a decrease of the cold spot temperature at which optimum efficiency is achieved.

The invention relates to a low-pressure gas discharge lamp equipped with a gas discharge vessel enclosing a gas filling comprising a discharge-maintaining composition including a molecular radiator and a buffer gas and also equipped with means for generating and maintaining a low-pressure gas discharge.

Light generation by a low-pressure gas discharge is based on the principle that charge carriers, particularly electrons but also ions, are accelerated so strongly by an electromagnetic field that collisions with the gas atoms or molecules in the gas filling of the lamp cause these gas atoms or molecules to be ionized or otherwise excited to a higher energy state without being ionized. As the excited atoms or molecules of the gas filling return to the ground state, a more or less substantial part of the excitation energy is converted to radiation.

Conventional low-pressure fluorescent gas discharge lamps comprise mercury in the gas filling and, in addition, a phosphor coating on the inside of the gas discharge vessel. A drawback of the mercury low-pressure gas discharge lamps is that mercury vapor primarily emits radiation in the high-energy, yet invisible UV-C range of the electromagnetic spectrum, which radiation must be converted by phosphors to visible radiation with a much lower energy level. In this process, the difference in energy is converted to undesirable thermal radiation.

In addition, the mercury in the gas filling is more and more regarded as an environmentally harmful and toxic substance that should be avoided as much as possible in present-day mass-products, as its use, production and disposal represents a threat to the environment.

Some new designs of low-pressure discharge lamps are therefore dosed with easily vaporizable metal compounds, known as “molecular radiators”, which comprise no mercury at all and thus cause no pollution and emit also at least partially in the visible range of the electromagnetic spectrum.

Nevertheless, since the first invention of low-pressure lamps comprising molecular radiators, a great effort has been made to maximize the efficacy of radiation generation from these lamps. One major problem encountered in this effort has been the production of UV-radiation outside the visible part of the spectrum, as mentioned above. Furthermore, the discharge vessel must be hot enough to vaporize the molecular radiators to an optimal temperature Tₒₚₜ.

For example, US2002047525 discloses a low-pressure gas discharge lamp provided with a gas discharge vessel containing a gas filling with an indium compound as the discharge-maintaining compound and a buffer gas, which low-pressure gas discharge lamp is also provided with electrodes and means for generating and maintaining a low-pressure gas discharge.

This indium-containing low-pressure gas discharge lamp emits in the visible range as well as in the UV range. Losses by Stokes' shift are reduced and less energy is wasted by radiative output in the ultraviolet range.

It is an object of the invention to provide a low-pressure gas discharge lamp having a radiation which is as close as possible to the visible range of the electromagnetic spectrum. It is another object of the present invention to improve the efficacy of such a discharge lamp.

According to the invention, this object is achieved by a low-pressure gas discharge lamp provided with a gas discharge vessel enclosing a gas filling with a discharge-maintaining composition comprising a) a molecular radiator compound, b) hydrogen as an additive and c) a buffer gas, which low-pressure gas discharge lamp is further provided with means for generating and maintaining a low-pressure gas discharge.

The essence of the present invention is that the chemistries of the gas filling comprising hydrogen allows the lamp to be run on a cooler level than without hydrogen.

A further advantage of the lamp of the invention is that it emits principally molecular radiation as opposed to atomic radiation, which results in a smoother spectrum without peaks or abrupt transitions and possibly a better color-rendering index.

Furthermore, the lamp is dimmable, has a relatively low flicker, and the fill is low pressure when turned off. In an electrodeless implementation, the lamp has a relatively long lifetime, and tends to maintain a uniform spectral output over lifetime. It also exhibits rapid starting.

In a preferred embodiment of the invention, the partial pressure of hydrogen in the gas phase at nominal operation is between 0.1 Pa and 5.0 Pa for improved plasma efficiency.

In a preferred embodiment, the molecular radiator is selected from the group formed by the halides of aluminum, gallium, indium, thallium, tin and germanium or mixtures thereof.

In the lamp in accordance with this embodiment, a molecular gas discharge takes place at low pressure, which molecular gas discharge emits radiation comprising the characteristic lines of aluminum, gallium, indium, thallium, tin and germanium present in the compounds of aluminum, gallium, indium, thallium, tin and germanium, while said radiation also includes a broad continuous spectrum in the range from 320 to 600 nm originating from the molecular radiation of the compounds of aluminum, gallium, indium, thallium, tin and germanium.

In a further embodiment, the gas filling further comprises an elemental metal selected from the group of line-emitting aluminum, gallium, indium, thallium, tin and germanium or mixtures thereof to “fill up” the emission spectrum of the lamp.

Typically, the gas filling also comprises, as a buffer gas, an inert gas selected from the group formed by helium, neon, argon, krypton and xenon or mixtures thereof, and the gas pressure of the inert gas at the operating temperature at nominal operation is below 100 mbar. Advantageously, the gas pressure of the inert gas at the operating temperature at nominal operation is below 100 mbar, with 2 mbar being the preferred value.

As an UV lamp comprising no phosphors, the lamp according to the invention is advantageously used as a tanning lamp or as a disinfecting lamp or as a lacquer-curing lamp.

For general illumination purposes, the lamp may be combined with appropriate phosphors, e.g. in a phosphor coating. In these embodiments, the gas discharge vessel comprises a phosphor coating on the inner or outer surface of the wall of the discharge vessel.

In combination with suitable phosphors, the lamp according to the invention has an overall luminous efficacy which may be higher than that of conventional low-pressure mercury discharge lamps, as the losses caused by Stokes' displacement are smaller than for a mercury-based discharge. “Luminous efficacy”, expressed in lumen/Watt, is defined as the ratio between the total luminous flux emitted by the lamp and the total power input to the lamp.

The luminous efficacy of the lamp may be further improved by a heat-reflective coating, reflecting infrared energy emitted by the wall of the discharge vessel back towards the discharge area. The temperature in this area is increased and maintained without any increase of input power from the excitation source

A low-pressure discharge lamp according to the invention may comprise means for generating a low-pressure gas discharge, which are selected from means comprising at least one inner electrode, means comprising at least one outer electrode and electrodeless means.

These and other aspects of the invention are apparent from and will be elucidated with reference to a drawing and an embodiment.

The invention relates to a low-pressure gas discharge lamp provided with a gas discharge vessel comprising a gas filling with a discharge-maintaining composition comprising a) a molecular radiator compound, b) hydrogen as an additive and c) a buffer gas, which low-pressure gas discharge lamp is further provided with means for generating and maintaining a low-pressure gas discharge.

In this specification, the term “low-pressure discharge” is understood to mean a discharge wherein the pressure of the filling during operation of the lamp stays below the atmospheric pressure. Usually, the total pressure of the gas filling in the lamp in operation will be below 200 hPa.

The design of the low-pressure gas discharge according to the invention may comprise electrodes as means for igniting and maintaining the molecular gas discharge.

The electrode-comprising design is either of the typical “tube lamp”-type (TL) as known in the art, with the main electrodes inside the discharge vessel. Otherwise, the lamp design is of the “dielectric barrier discharge”-type (DBD), with at least one main electrode outside the vessel or—for capacitive operation—both main electrodes are arranged outside the vessel.

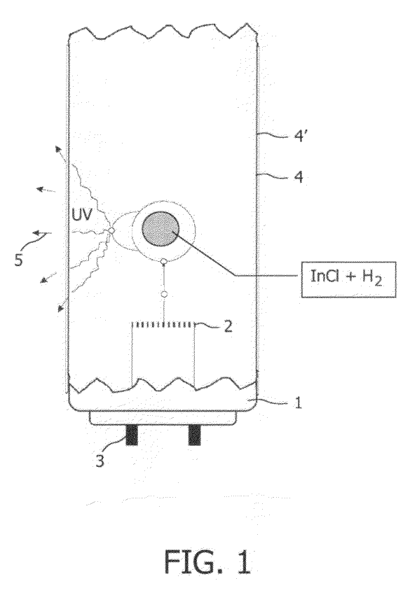

In one embodiment of the invention as shown in FIG. 1, the low-pressure gas discharge lamp according to the invention is composed of a tubular discharge vessel 1, which encloses a discharge space. Inner electrodes 2, via which the gas discharge can be ignited, are sealed in at both ends of the tube. The low-pressure gas discharge lamp comprises a lamp holder and a lamp cap 3. An electric ballast is integrated in known manner in the lamp holder or in the lamp cap, which ballast is used to control the ignition and operation of the gas discharge lamp. In a further embodiment, not shown in FIG. 1, the low-pressure gas discharge lamp can be alternatively operated and controlled via an external ballast.

The gas discharge vessel may be alternatively embodied as a multiple-bent or coiled tube surrounded by an outer bulb.

The wall of the gas discharge vessel is preferably made of a light-transmissive material such as glass, quartz or ceramics (i.e. aluminum oxide).

Suitable materials for the electrodes in those embodiments of the invention which comprise electrodes are selected from nickel, a nickel alloy or a metal having a high melting point, in particular tungsten and tungsten alloys. Also composite materials of tungsten with thorium oxide or zinc oxide can be suitably used. By providing emitter material on the electrode, the work function of the electrode can be further reduced.

In further embodiments, the lamp according to the invention does not necessarily rely on electrodes, but rather produces light by creating a plasma discharge by inductively coupling the lamp gas filling to intense radio wave or radio frequency radiation. As used herein, the phrase “radio wave radiation”, as well as the acronym “RF”, is understood to encompass electromagnetic radiation frequencies in either the conventional radio frequency range or in the conventional microwave frequency range. The RF source is an RF antenna, a probe, or the like for introducing RF energy into the waveguide.

The electrodeless lamp includes a discharge vessel, which has a tubular, closed-loop configuration. The discharge vessel can be made in almost any shape, even an asymmetrical shape that forms a closed-loop discharge path.

In a typical electrodeless low-pressure gas discharge lamp utilizing inductively coupled plasma, an induction coil is inserted inside a reentrant cavity. The induction coil typically has several turns and an inductance of 1-3 μH. It is energized by a special driver circuit commonly including a matching network (MNW). The RF voltage generated by the driver circuit of fixed frequency (typically 2.65 MHz or 13.56 MHz) is applied across the induction coil. This RF voltage induces a “capacitive” RF electric field in the lamp. When the electric field in the discharge vessel reaches its breakdown value, the capacitive RF discharge ignites the gas mixture in the lamp along the turns of the coil.

Otherwise, radio-frequency energy from an RF source is inductively coupled to the electrodeless lamp by a first transformer core and a second transformer core; each transformer core has a toroidal configuration that surrounds the discharge vessel. The RF source is connected to a winding on the first transformer core and to a winding on the second transformer core.

Each winding may comprise a few turns of wire of sufficient size to convey the primary current. Each transformer is configured to step down the primary voltage and step up the primary current typically by a factor of about 5 to 10. The RF source is preferably in a range of about 50 kHz to 3 MHz and is most preferably in a range of about 100 kHz to about 400 kHz.

As shown by way of example in the embodiment shown in FIG. 1, the inner and/or the outer surface of the gas discharge vessel of the lamp is coated with a phosphor layer 4. The UV-radiation originating from the gas discharge excites the phosphors in the phosphor layer so as to emit light in the visible region 5.

The chemical composition of the phosphor layer determines the spectrum of the light or its tone. The materials that can be suitably used as phosphors must absorb the radiation generated and emit said radiation in a suitable wavelength range, for example, for the three basic colors red, blue and green, and enable a high fluorescence quantum yield to be achieved.

Suitable phosphors and phosphor combinations must not necessarily be applied to the inside of the gas discharge vessel; they may be alternatively applied to the outside of the gas discharge vessel, as the customary glass types do not absorb UV-A radiation.

These embodiments can be improved by depositing a thin, non-conductive infrared reflective coating 4′ on the outer walls of the discharge vessel. The reflective coating is deposited either by evaporation, spraying, painting or another method. The material used is tin oxide or a similar reflective material. The function of the coating is to reduce the infrared radiation loss of the walls of the vessel and thereby increase the wall temperature of the vessel or achieve the same temperature at a lower electric input power of the lamp.

The losses by infrared radiation can also be further reduced by using a heat-reflective outer envelope.

Irrespective of the mode of igniting and maintaining the low-pressure discharge, the discharge vessel encloses a discharge area containing a gas filling that includes a molecular radiator and hydrogen, but does not include mercury or mercury compounds.

The following definitions are used in the present application.

The term “nominal operation” is used to indicate operational conditions in which the discharge-maintaining composition has such a vapor pressure that the radiant efficiency of the lamp is at least 80% of the maximum radiant efficiency for this lamp, i.e. operating conditions in which the pressure of the radiating species is optimal.

The term “partial pressure” is understood to mean the partial pressure which prevails in a non-operating gas discharge lamp, when this lamp has a temperature equal to the temperature of the portion of the lamp which defines the pressure of the molecular radiator in the situation in which the lamp is on. This is usually the coldest spot in the discharge space of the lamp, while the lamp is operated at an ambient temperature of 25° C.

Under these conditions, that portion of the molecular radiator which is in the gaseous state is distributed substantially homogeneously in the discharge vessel. The partial pressure serves as a measure for indicating how much of a certain substance is present in the gaseous state of a gas discharge lamp in operation.

It will be evident to those skilled in the art that a discharge can be designed to be either dose-limited or vapor pressure-limited, or a combination of dose and vapor pressure-limited.

In a dose-limited discharge vessel, the entire molecular radiator present is vaporized during operation of the arc.

A vapor pressure-limited design requires a portion of each molecular radiator to be present as condensate during operation of the arc. During operation, a non-uniform temperature distribution is formed in the discharge vessel. Typically, at least one hot region and at least one cold region are formed, resulting in thermal gradients across the discharge vessel. Typically, the molecular radiators in the discharge vessel migrate to the coldest part of the discharge vessel (“Cold Spot”) and condense on the wall.

Thus, in a vapor-limited lamp design, the total mass of the molecular radiator filling in the lamps is greater than that of the molecular radiator in the vapor phase at nominal operation, which is required to achieve the desired color and efficacy. As a result, the vapor phase is in equilibrium with the condensed phase located on the cold spot of the discharge vessel. The composition of the condensed phase of the fill, and consequently the composition of the vapor phase, due to the differences in the thermal-chemical properties of the components of the gas filling, clearly depends on the temperature of the cold spot in the discharge vessel of the lamp.

The value of this cold spot temperature depends on the physical characteristics of the discharge vessel itself as well as on the variations in characteristics of the discharge-maintaining means of the lamp.

The design of the lamp according to the invention is typically of the vapor pressure-limited type.

For the gas filling, use is made, in one embodiment, of a molecular radiator selected from the halides of aluminum, gallium, indium, thallium, tin and germanium.

The amount of molecular radiator is typically an amount in the range of a quantity of 2×10⁻¹¹ mole/cm³ to 2×10⁻⁸ mole/cm³.

It should be noted that the absolute amount of the molecular radiator component in solid form which is used in the discharge vessel may vary in dependence on which substance is used, but the amount will always be such that the desired pressure range is produced at the operating temperature, i.e. the temperature of the discharge vessel during nominal operation.

In some embodiments, the discharge vessel will also contain at least one or more additional elemental metals, illustrative, but non-limiting examples of which include aluminum, gallium, indium, thallium, tin and germanium and mixtures thereof.

Hydrogen is dosed into the lamp in such a way that the partial pressure at nominal operation is between 0.1 and 5 Pascal. This specification relates to “free” hydrogen, as part of the dosed hydrogen is absorbed by the walls and eventually by the electrode materials or undergoes a chemical reaction, which does not yield a gaseous species.

The discharge vessel typically also contains a buffer gas which is inert to the extent that it does not affect the operation of the lamp and acts as a buffer to reduce chemical transport from the arc to the discharge vessel wall and also preferably contributes to igniting the arc. Rare gases are suitable buffer gases. Although any rare gas will work to some extent, preferred gases are argon (Ar), helium (He), krypton (Kr), xenon (Xe), and mixtures thereof, with argon and mixtures thereof with other rare gases being particularly preferred.

The buffer gas typically has a partial pressure at nominal operation in the range of maximally 100 hPa. Said pressure is preferably in a range between 1.0 and 5.0 hPa, more preferably at 2.5 hPa.

Possible further additives as well as the internal pressure of the lamp and the operating temperature allow control of the plasma efficiency and of the composition of the emission spectrum.

When a low-pressure discharge lamp is ignited, the means for igniting and maintaining a discharge produce an electric field inside the discharge vessel and start a glow discharge in the buffer gas.

The discharge quickly progresses from a glow discharge (low power) to an arc-discharge (high power) and a significant amount of molecular radiators is vaporized.

The electric field ionizes also the buffer gas within the discharge area. The electrons stripped from the buffer gas atoms and accelerated by the electric field collide with radiating species of molecular radiators. As a result, some species become excited to a higher energy state without being ionized. As the excited species fall back from the higher energy state, they emit photons, ultraviolet (UV) photons and/or visible photons.

In the embodiments comprising a phosphor, the UV photons interact with the phosphor in the phosphor layer of the lamp to generate visible light.

The intensity of the visible light generated by the lamp depends on the partial pressure of the vaporized molecular radiator in the discharge vessel. The visible light reaches its maximum intensity and the lamp operates at maximum efficacy at an optimum partial pressure of the molecular radiator. At a partial pressure less than the optimum pressure, the light intensity of the lamp is less than maximum because the excited species produce fewer photons. At a pressure greater than the optimum pressure, the light intensity of the lamp is also less than maximum because some of the species collide with the photons generated by other species and these photons get re-absorbed and do not generate UV or visible radiation.

The vapor pressure in turn depends on the temperature of the cold spot inside the discharge vessel. The optimal cold spot temperature, at which the pressure within the discharge vessel of a prior-art lamp is at the optimum value, is e.g. 200° C. Therefore, to ensure that the visible light output of the lamp is at a maximum and that the lamp operates at maximum efficacy, it is necessary to regulate the cold spot temperature of the prior-art lamp tube to maintain the optimal cold spot temperature at 200° C. by means of suitable constructional measures. The diameter and the length of the lamp are chosen to be such that, during operation at an outside temperature of 25° C., an inside temperature in the range of e.g. 200° C. is attained.

According to the invention, the optimal cold spot temperature value Tₒₚₜ, at which the fill pressure reaches the optimal value can be lowered.

The optimal cold spot temperature of the lamp according to the invention for maintaining the light output of the lamp at substantially maximum intensity is e.g. 185° C.

Due to the lower wall temperature of the discharge vessel, smaller heat losses can be achieved. This can be utilized, for example, to run the lamp at lower power densities with the opportunity to have a higher radiation efficiency.

The best evidence for the benefit of the invention comes from a direct comparison of the performance of an arc tube with and without hydrogen.

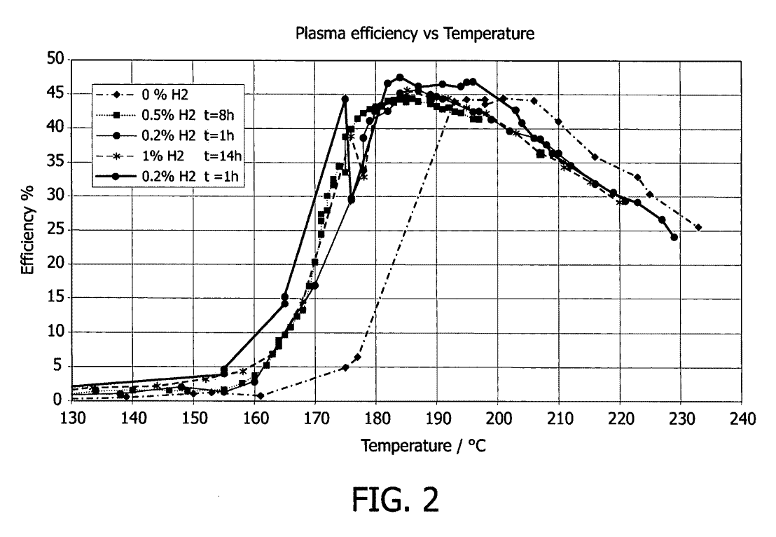

The curves given in FIG. 2 for the example of an indium chloride discharge demonstrate that Tₒₚₜ of the “cold spot” can be reduced from 200° C. to 185° C. if hydrogen is present. At the same time, plasma efficiency is increased from 44% without hydrogen to 47%. The spectral emission of the plasma is not changed.

Without the added hydrogen, the self-absorption characteristics of the gas filling near the cooler discharge vessel walls would act to limit the lamp efficacy at lower cold spot temperatures.

In a specific embodiment, the discharge vessel is made from fused silica, has a length of 25 cm and a diameter of 2.5 cm and is provided with outer electrodes of conductive material. The discharge vessel is evacuated and a dose of 0.1 mg indium chloride and 0.05 mg indium is added simultaneously. Also argon is introduced at a pressure of 2.5 hPa at ambient temperature. Hydrogen is added to the argon buffer gas as 0.2, 0.5 or 1 volume percent. A high frequency field having a frequency of 13.56 MHz is supplied from an external source and, at an operating cold spot temperature of 185° C., maximal plasma efficiency is measured.

In FIG. 2, the plasma efficiency as a function of cold spot temperature Tₒₚₜ is shown together with the curve obtained for a lamp without hydrogen additive. The results are given for lamps filled with 2.5 hPa argon buffer gas with 0%, 0.2%, 0.5% and 1% hydrogen content after different operating times.

The curves demonstrate that Tₒₚₜ is decreased from 200° C. to 185° C. if hydrogen is present. Plasma efficiency is increased from 44% without hydrogen to 47%. The spectral emission of the plasma is not changed.

FIG. 1 shows diagrammatically the light generation in a low-pressure gas discharge lamp comprising a gas filling containing an indium(I) compound plus hydrogen.

FIG. 2 shows the plasma efficiency as a function of cold spot Tₒₚₜ of low-pressure gas discharge lamps comprising a gas filling containing indium chloride and different amounts of hydrogen as an additive in comparison with a lamp without hydrogen.

1. A low-pressure gas discharge lamp provided with a gas discharge vessel enclosing a gas filling with a discharge-maintaining composition comprising a) a molecular radiator compound, b) hydrogen as an additive and c) a buffer gas, which low-pressure gas discharge lamp is further provided with means for generating and maintaining a low-pressure gas discharge.

2. A low-pressure gas discharge lamp as claimed in claim 1, wherein the partial pressure of hydrogen in the gas phase is between 0.1 Pa and 5.0 Pa.

3. A low-pressure gas discharge lamp as claimed in claim 1, wherein the molecular radiator compound is selected from the group formed by the halides of aluminum, gallium, indium, thallium, tin and germanium or mixtures thereof.

4. A low-pressure gas discharge lamp as claimed in claim 1, characterized in that the gas filling further comprises an elemental metal selected from the group of aluminum, gallium, indium, thallium, tin and germanium or mixtures thereof.

5. A low-pressure gas discharge lamp as claimed in claim 1, wherein the gas filling comprises a buffer gas selected from the group formed by helium, neon, argon, krypton and xenon or mixtures thereof.

6. A low-pressure gas discharge lamp as claimed in claim 5, wherein the partial pressure of the buffer gas at nominal operation is below 100 hPa.

7. A low-pressure gas discharge lamp as claimed in claim 1, characterized in that it comprises a phosphor coating.

8. A low-pressure gas discharge lamp as claimed in claim 1, characterized in that it comprises an infrared-reflective coating.

9. A low-pressure gas discharge lamp as claimed in claim 1, characterized in that the means for generating a low-pressure gas discharge are selected from the means comprising at least one inner electrode, means comprising at least one outer electrode and electrodeless means.
